(19) United States
(12) Patent Application Publication
(10) Pub. No.: US 2010/0081459 A1
(43) Pub. Date: Apr. 1, 2010

(54) Wireless communication system for distributing paging messages and method thereof

(76) Inventors: Peter Bosch, Amstelveen (NL); Geoffrey A. Collyer, New Providence, NJ (US); Jean-Marc Fenart, Montigny (FR); Sudhir Umarale, Morris Plains, NJ (US); Humberto LaRoche, Wayside, NJ (US); Denis Fauconnier, Chevreuse (FR); Ajay Rajkumar, Morristown, NJ (US); Indra Widjaja, Roseland, NJ (US)

Correspondence Address: HARNESS, DICKEY & PIERCE, P.L.C., P.O. BOX 8910, RESTON, VA, 20195, US

(21) Appl. No.: 12/285,150

(22) Filed: Sep. 30, 2008

(51) Int. Cl. H04W 68/00; H04H 20/71; H04L 9/00

(52) U.S. Cl. 455/458; 370/312; 380/271

(57) ABSTRACT

The present invention relates to a method and apparatus for distributing paging messages in a wireless communication system. The wireless communication system may include a paging controller configured to distribute the paging messages in a paging area, a paging group including a plurality of base stations within the paging area configured to receive the paging message, and a paging interface between the paging controller and the paging group configured to support transmission of only the paging messages to all the plurality of base stations through a single transmission of the paging message from the paging controller. The method may include distributing a paging message to all of a plurality of base stations through a single transmission of a paging message from a paging controller over a secured IP-multicast group.

### BACKGROUND

To conserve battery power, wireless mobile terminals maintain a dormant state. This state is characterized by a mobile terminal only listening to the wireless communication network's broadcast channels and only to re-establish a bi-directional communication channel when either the mobile terminal itself or a communication peer needs to exchange information. To find a dormant mobile terminal in a wireless communication network, wireless communication systems typically use a technique called paging to wake up a dormant mobile terminal and have the dormant mobile terminal re-initiate a communication channel to the wireless communication network. For example, base stations in an area broadcast a special message over the air with the identity of the mobile terminal that the mobile terminal recognizes as a request to reestablish a communication channel.

FIG. 1 illustrates a conventional wireless communication system 100 for distributing paging messages. The conventional wireless communication system 100 includes a paging controller 101, a plurality of base stations 110, and a paging interface 102. The plurality of base stations 110 includes base station 110_1 through base station 110_N. In response to an incoming call for a dormant mobile terminal 120, the paging controller 101 distributes a paging message to each of the plurality of base stations 110 within a paging area via the interface 102. The paging message is a request to re-establish bi-directional communication with the wireless communication system 100.

In conventional wireless communication systems, the paging interface 102 is configured to support a unicast mechanism to distribute the paging message to the plurality of base stations 110. The unicast mechanism addresses each of the plurality of base stations 110 individually for the delivery of the paging message at those base stations 110. For instance, referring to FIG. 1, when a paging message is sent from the paging controller 101, each of the plurality of base stations 110 individually receives the paging message. After the plurality of base stations 110 receive the paging message, the plurality of base stations 110 in the paging area broadcast the paging message over the air with the identity of the mobile terminal 120 such that the mobile terminal 120 recognizes the paging message as a request to reestablish a communication channel.

Currently, the conventional wireless communication system 100 only utilizes a unicast mechanism for distributing paging messages to the plurality of base stations 110. For instance, most wireless communication systems using unicast mechanisms to address each base station in the paging group individually for the delivery of paging messages at those base stations. The unicast mechanism requires a relatively high number of transmissions, which increases signal loading at the paging controller 101. For instance, the paging controller 101 must send paging messages to each of the plurality of base stations 110 individually. This requires N transmissions of paging messages, where N is the number of base stations 110 within a paging area. Furthermore, in response to every paging message transmitted from the paging controller 101 to the plurality of base stations 110, the plurality of base stations 110 must transmit N acknowledgment messages. Due to the high number of transmissions of the paging messages and acknowledgment messages used within the unicast mechanism, paging dormant mobile terminals is a costly operation requiring expensive equipment to handle the high level of loading at the paging controller.

### SUMMARY

The present invention relates to a method and apparatus for distributing paging messages in a wireless communication system.

In one embodiment, a wireless communication system includes a paging controller configured to distribute paging messages in a paging area. The wireless communication system includes a paging group that includes a plurality of base stations within the paging area configured to receive the paging messages from the page controller. Each of the plurality of base stations is registered to the paging group and the paging controller.

The wireless communication system includes a paging interface between the paging controller and the paging group configured to support transmission of only the paging messages to all of the plurality of base stations through the single transmission of a paging message from the paging controller. The paging controller distributes the paging messages through IP multicasting independently of other signaling distribution.

The paging interface is configured to secure the distribution of the paging messages to prevent non-members of the paging group from obtaining the paging information. The paging interface may secure the distribution of the paging messages through an Encapsulated Security Protocol. Each of the plurality of base stations and the paging controller share an encryption key that enables the paging controller to encrypt the paging message. In addition, each of the plurality of base stations and the paging controller share an authentication key that enables the plurality of base stations to authenticate the paging message. The encryption key and the authentication key are different from the authentication key for other signaling distribution.

The paging interface is configured to transmit a notification of call establishment with a paged mobile terminal, where the notification operates as an implicit acknowledgment message. The notification of call establishment is transmitted when the paging interface establishes a link to a serving base station and the serving base station establishes a link to the dormant mobile terminal.

In one embodiment, the method includes distributing a paging message to all of a plurality of base stations through the single transmission of a paging message from a paging controller. The method may further include registering the plurality of base stations and the paging controller to a paging group to allow transmission of only paging messages through a paging interface, where the paging group is associated with a paging area.

The method further includes securing the distribution of the paging messages to prevent non-members of the paging group from obtaining paging information, and transmitting a notification of call establishment with a paged mobile terminal, where the notification operates as an implicit acknowledgment message.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates a conventional wireless communication system for distributing paging messages;

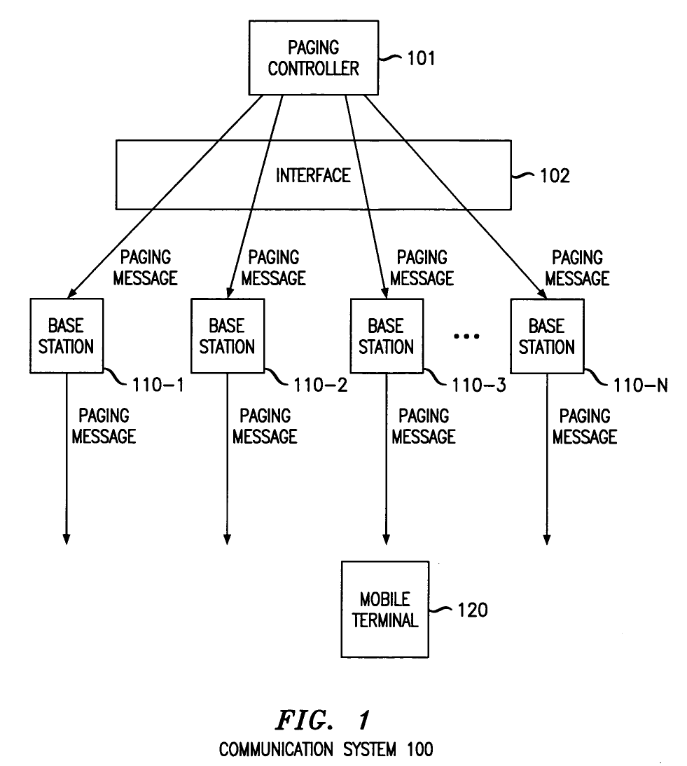

FIG. 2 illustrates a wireless communication for distributing paging messages according to example embodiments;

FIG. 3 illustrates a method of using an IP-multicast mechanism to securely distribute paging messages from the paging controller to all members of the paging group according to example embodiments; and

FIG. 4 illustrates a graph showing a comparison of Mobility Management Entity (MME) signaling loads with and without multicasting paging information.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity. Like numbers refer to like elements throughout the description of the figures.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term “mobile” and/or “mobile terminal” may be considered synonymous to, and may hereafter be occasionally referred to, as a mobile unit, mobile station, mobile user, user equipment (UE), subscriber, user, remote station, access terminal, receiver, etc., and may describe a remote user of wireless resources in a wireless communication network. The term “base station” may be considered synonymous to and/or referred to as a base transceiver station (BTS), base station, NodeB, an enhanced NodeB, etc. and may describe equipment that provides data and/or voice connectivity between a network and one or more users. The term “paging controller”, “central paging control”, and/or “controller” may be considered synonymous to and/or referred to as a mobility management entity (MME), radio network controller (RNC), base station controller (BSC), anchor paging controller (A-PC), etc. and may describe equipment that distributes information in a wireless network to a base station.

As is well-known in the art, each of a mobile and a base station may have transmission and reception capabilities. Transmission from the base station to the mobile is referred to as downlink or forward link communication. Transmission from the mobile to the base station is referred to as uplink or reverse link communication.

According to example embodiments, an IP-multicast mechanism is utilized to distribute paging messages to all of the members of a paging group through the single transmission of a paging message from a central paging controller. A paging group may include a plurality of base station. Each member of the paging group registers itself of the IP-multicast group, and the paging controller only transmits the paging messages on the IP-multicast group. To date, IP-multicast techniques have not been used for distributing paging messages from the paging controller to the paging group. Although example embodiments illustrated in this application are discussed with respect to distributing paging messages, example embodiments of the present invention are not limited to only paging messages. For instance, other types of information may be distributed according to the apparatus and method of the present invention, such as broadcast information and power level operation information.

According to example embodiments, the multicast mechanism is secured through an Encapsulated Security Protocol (“ESP”) to prevent the leaking of paging information to un-authorized recipients. The ESP enables secrecy and authenticity of the paging messages by sharing an ESP-key per paging group. The base stations are then capable of determining which paging controller transmitted the paging message and by sharing an ESP-key per paging group, only those base stations that are members of the paging group can decrypt the paging message. The reason the paging messages need to be secured is to verify that non-members of the paging group that may have received the IP-multicast message cannot obtain the paging information.

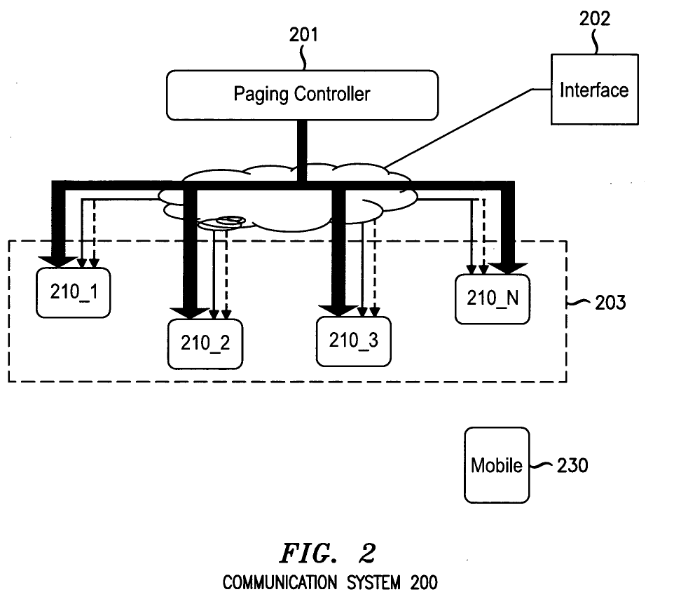

FIG. 2 illustrates a wireless communication system 200 for distributing secured paging messages according to example embodiments. Referring to FIG. 2, the communication system 200 includes a paging controller 201, a paging interface 202, and a paging group 203. The paging group 203 includes a plurality of base stations 210 within a paging area. Referring to FIG. 2, the plurality of base stations 210 includes base station 210_1 through base station 210_N. N is an integer greater than or equal to 1. The plurality of base stations 210 is located within a paging area and configured to receive a paging message from the paging controller 201 via the paging interface 202.

Each of the plurality of base stations 210 is registered to the paging group 203 and the paging controller 201 within the paging area. It is noted that one or more of the plurality of base stations 210 may be registered to multiple paging groups, but the paging areas associated with the multiple paging groups do not necessarily need to overlap. The paging interface 202 is located between the paging controller 201 and the paging group 203. The paging message may be a request to re-establish a communication channel of a dormant mobile terminal 230 within the paging area to the wireless communication system 200.

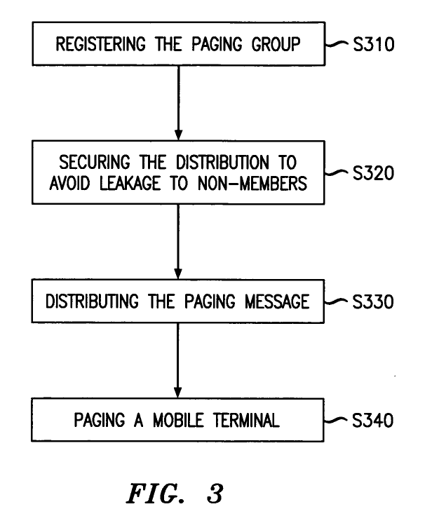

FIG. 3 illustrates a method of using an IP-multicast mechanism to securely distribute paging messages from the paging controller 201 to each member of the paging group 203 according to example embodiments.

Referring to FIG. 3, at S310, each of the plurality of base stations 210 and the paging controller 201 registers to an IP-multicast group. The IP-multicast mechanism allows the paging controller 201 to distribute the paging messages via the interface 202 to all members of the paging group 203 through a single transmission of a paging message from the paging controller 201. In contrast, a unicast mechanism would address and transmit paging messages to each base station in the paging group 203 individually for the delivery of paging messages at the plurality of base stations. IP multicast mechanisms are well known in the art, and therefore the details are omitted for the sake of brevity.

The paging controller 201 only transmits the paging messages to the plurality of base stations 210 through the paging interface 202. For example, the paging interface 202 is configured to support transmission of only the paging message. Other signaling distribution is separated from the paging distribution. Only the paging messages are transmitted through the IP-multicast mechanism, while the remaining signaling distribution is transmitted in unicast form.

Referring again to FIG. 3, at S320, the communication system 200 may secure the distribution of paging messages to prevent non-members of the paging group from obtaining the paging information. For example, all members of the paging group 203 and the paging controller 201 share a pre-established encryption and/or authentication key that enables the paging controller 201 to encrypt and sign the paging message. For instance, before the paging controller 201 sends the paging message to the plurality of base stations, the paging controller 201 encrypts the paging message using an encryption key, where only the registered base stations 210 can decrypt the paging message. The plurality of base stations 210 authenticate the paging message before broadcasting the paging message using the authentication key. Therefore, only the base stations that are members of the paging group 203 can decrypt the paging message and non-members of the IP-multicast group cannot obtain the paging information. The encryption and authentication key for the transmission of paging messages is different from the encryption and authentication key for other signaling distribution. According to an example embodiment, the paging interface 202 may secure the distribution of the paging messages through an encryption protocol such as ESP, for example. The encryption and authentication key can be established based on Advanced Encyption Standard (AES), three-step Data Encryption Standard (3DES), 56 bit Data Encryption Standard (DES), or Rivest Cipher 4 (RC4), for example.

Paging areas may change over time. To prevent leakage of encryption and authentication keys to previous members of a paging group, every time a paging area is changed, the paging area renegotiates, or establishes a new encryption and authentication key for the IP multicast group. A paging area is changed when the operator lays out a new paging structure.

At S330, the paging controller 201 distributes the paging message via the paging interface 202 to all of the plurality of base stations (e.g., the paging group 203) through a single transmission of a paging message. According to an example embodiment, an implicit acknowledgment message (as described below) is utilized to acknowledge the paging message as compared to conventional wireless systems which utilizes a protocol layer (SCTP) to transmit acknowledgment messages from the base stations to the paging controller 201 in response to the paging message received at the plurality of base stations 210.

For example, in conventional wireless systems, acknowledgment messages are sent from the base stations to the paging controller in response to each paging message received at the plurality of base stations. For instance, in conventional wireless systems, the paging controller transmits N paging messages to each of the base stations, where N is the number of base stations within a paging area. Therefore, in response to each N paging messages, N base station responds with N acknowledgment messages. If the number of base station is 100, then the paging controller would be required to have the capacity to receive 100 acknowledgment messages to page one dormant mobile terminal, which may overload the conventional wireless system.

According to example embodiments, the paging controller 201 does not receive N acknowledgment messages every time a paging message is received at the plurality of base stations 210. Instead, explicit acknowledgment messages from the plurality of base stations 210 to the paging controller 201 are not necessary. Rather, when the dormant mobile terminal 230 answers the paging message from a particular base station, the dormant mobile terminal 230 thereby re-establishes communication with the wireless communication system including a notification to the paging controller 201. This notification operates as an implicit acknowledgment message. For example, as soon as the mobile terminal wakes up, the paging interface 202 sets up a link to the appropriate serving base station, which then sets up a link to the paging controller 201. This link provides an implicit acknowledgment of the paging message having been received.

At S340, the plurality of base stations broadcast the paging message within the paging area to the dormant mobile terminal 230. Illustrating, once the paging message is received at the plurality of base stations, they broadcast the paging message that includes the identity of the dormant mobile terminal 230. The dormant mobile terminal 230 receives the paging message and recognizes the paging message as a request to re-establish communication with the communication system 200.

According to an example embodiment, the paging area is defined as a group of one or more cells that are broadcast from the one or more base stations and is typically formed based on geographical conditions. A typical paging area may include approximately 50-100 base stations per paging controller, but larger group sizes can occur as well.

An operation of paging the mobile terminal will be described below with reference to FIG. 2 according to example embodiments. The paging controller 201 records the last known location of a dormant mobile terminal. For instance, the paging controller 201 records a mapping between the dormant mobile terminal's identity and a paging area in which the dormant mobile terminal 230 last registered.

The mobile terminal's identity may be an IP address and mapped by a layer-3 anchor for IP-only capable mobile terminals, for example. Alternatively, the mobile terminal's identity may be a telephone number, which is typical of older cellular technologies. In addition, the mobile terminal's identity may be a Media Access Control (MAC) address. The mobile terminal's identity may include other types of addresses, such as international mobile subscriber identity (IMSI), temporary mobile subscriber identity (TMSI), packet TMSI (PTMSI), unicast access terminal identifier (UATI) and GUTI, for example. When a call arrives for the dormant mobile terminal 230, the paging area may broadcast the paging message over the air to find and activate the dormant mobile terminal 230 under the control of the paging controller 201.

Also, the base stations that are members of the same paging area broadcast information to indicate their membership in the paging area. The dormant mobile terminal 230 periodically listens to the broadcast information from all the surrounding cells and compares the paging area with the paging area in which the dormant mobile terminal 230 last registered. Based on the comparison, if the dormant mobile terminal 230 is still in the same paging area, the dormant mobile terminal 230 remains dormant. In contrast, if the dormant mobile terminal 230 moves into a new paging area, the dormant mobile terminal 230 re-registers in the new paging area and with the paging controller associated with the new paging area. For example, a paging update message is transmitted from the dormant mobile terminal 230 to the new paging controller in the new paging area. Therefore, the wireless communication system 200 always knows the location of the dormant mobile terminal 230 by the paging area and paging controller to which the dormant mobile terminal 230 is registered.

The optimal size of a paging area depends on a few factors. If the paging area is too small, the dormant mobile terminal 230 needs to be activated frequently to re-register in a new paging area, while if the paging area is large, backhaul and radio resource requirement are high.

According to example embodiments, the wireless communication system 200 may be Long Term Evolution (LTE), Universal Mobile Telecommunication System (UMTS), Global System for Mobile communications (GSM), Worldwide Interoperability for Microwave Access (WiMAX), Code division multiple access (CDMA), and Time division multiple access (TDMA), for example.

In the LTE system, the paging controller 201 may be a mobility management entity (MME) and the plurality of base stations may be evolved Node Bs (eNBs). The paging interface 202 may be S1-P (S1-page). The paging interface S1-page operates in the same manner as described with reference to the paging interface 202 described above. The MME may be the head of the multicast group and the MME distributes the paging messages via the paging interface S1-P to participating eNBs.

The paging interface for the Universal Mobile Telecommunication System (UMTS), Global System for Mobile communications (GSM), Worldwide Interoperability for Microwave Access (WiMAX), Code division multiple access (CDMA), and Time division multiple access (TDMA) wireless communication systems may be similar to the paging interface 202 described above.

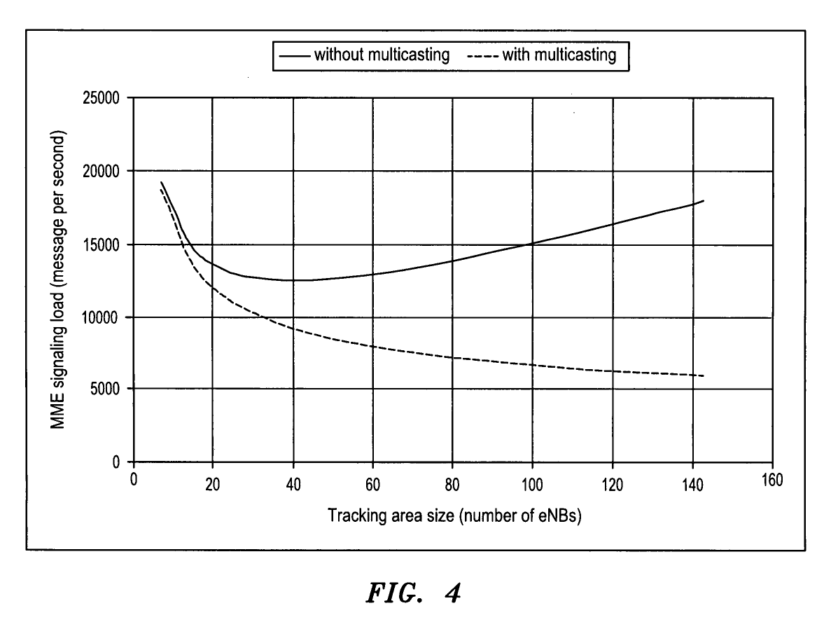

FIG. 4 illustrates a graph showing a comparison of MME signaling loads with and without IP multicasting paging information. For example, the graph compares the signaling loads at the MME with and without IP multicasting paging information as a function of a tracking area size for a wireless communication network. The graph in FIG. 4 is based an architecture with a centralized MME serving a large region of eNBs.

Referring to FIG. 4, the signaling load without multicasting is very high when the tracking area is very small as tracking area updates tend to dominate the signaling load. As the tracking area size increases initially, the signaling load decreases since tracking area updates drop appreciably. However, the signaling load at some point begins to increase as network-initiated connections (which require paging) dominate the signaling load. With IP multicasting, the signaling load decreases as the tracking area size increases because no additional overhead in paging messages is incurred. The performance result shows a drastic reduction of page messaging load if multicast/broadcast messages can be used to disperse paging messages over the wireless communication system backhaul network.

According to example embodiments, signaling load on the paging controller may be reduced while avoiding leaking paging information outside the paging area.

Example embodiments being thus described, it will be obvious that the same may be varied in many ways. Such variations are not to be regarded as a departure from the invention, and all such modifications are intended to be included within the scope of the invention.

I claim:

1. A wireless communication system for distributing paging messages, the system comprising:
a paging controller configured to distribute the paging messages in a paging area;
a paging group including a plurality of base stations within the paging area configured to receive the paging messages from the page controller; and
a paging interface between the paging controller and the paging group configured to support transmission of only the paging messages to all the plurality of base stations through a single transmission of the paging message from the paging controller.

2. The wireless communication system of claim 1, wherein the paging interface is configured to secure the distribution of the paging messages to prevent non-members of the paging group from obtaining paging information.

3. The wireless communication system of claim 2, wherein the paging interface secures the distribution of the paging messages through an Encapsulated Security Protocol.

4. The wireless communication system of claim 2, wherein the each of the plurality of base stations and the paging controller share an encryption key that enables the paging controller to encrypt the paging message, the encryption key being different from the encryption key for other signaling distribution.

5. The wireless communication system of claim 2, wherein the each of the plurality of base stations and the paging controller share an authentication key that enables the plurality of base stations to authenticate the paging message, the authentication key being different from the authentication key for other signaling distribution.

6. The wireless communication system of claim 1, wherein the paging interface is configured to transmit a notification of call establishment with a paged mobile terminal, further wherein the notification operates as an implicit acknowledgment message.

7. The wireless communication system of claim 6, wherein the notification of call establishment is transmitted when the paging interface establishes a link to a serving base station and the serving base station establishes a link to the dormant mobile terminal.

8. The wireless communication system of claim 1, wherein the paging controller distributes the paging messages through IP multicasting independently of other signaling distribution.

9. The wireless communication system of claim 1, wherein each of the plurality of base stations is registered to the paging group and the paging controller.

10. A method for distributing paging messages within a wireless communication system, the method comprising:
distributing a paging message to all of a plurality of base stations through a single transmission of a paging message from a paging controller.

11. The method of claim 10, further comprising:
paging a mobile terminal within a paging area based on the paging message received at the plurality of base stations.

12. The method of claim 10, further comprising:
registering the plurality of base stations and the paging controller to a paging group to allow transmission of only paging messages through a paging interface, the paging group associated with a paging area.

13. The method of claim 12, further comprising:
securing the distribution of the paging messages to prevent non-members of the paging group from obtaining paging information.

14. The method of claim 13, wherein the paging message is secured through an Encapsulated Security Protocol.

15. The method of claim 13, wherein the step of securing the distribution includes sharing a pre-established encryption key between the plurality of base stations and the paging controller that enables the paging controller to encrypt the paging message, the encryption key being different from the encryption key for other signal distribution.

16. The method of claim 13, wherein the securing the distribution includes sharing an authentication key between the plurality of base stations and the paging controller that enables the plurality of base stations to authenticate the paging message, the authentication key being different from the authentication key for other signaling distribution.

17. The method of claim 10, further comprising:
transmitting a notification of call establishment with a paged mobile terminal, further wherein the notification operates as an implicit acknowledgment message.

18. The method of claim 17, wherein the notification of call establishment is transmitted when the paging interface establishes a link to a serving base station and the serving base station establishes a link to the dormant mobile terminal.

19. The method of claim 10, wherein the paging message is distributed through IP multicasting and independently of other signaling distribution.

20. A wireless communication system for distributing information, the system comprising:
a controller configured to distribute the information in an area;
a group including a plurality of base stations within the area configured to receive the information from the controller; and
an interface between the controller and the group configured to support transmission of only the information to all the plurality of base stations through a single transmission of the information from the controller.
